(19) United States
(12) Patent Application Publication
(10) Pub. No.: US 2005/0106469 A1
(43) Pub. Date: May 19, 2005

(54) Proton conductive composition and proton conductive membrane

(75) Inventors: Junji Kawai, Tokyo (JP); Toshihiro Otsuki, Tokyo (JP); Mayumi Kakuta, Tokyo (JP); Kohei Goto, Tokyo (JP); Nagayuki Kanaoka, Wako-shi (JP); Yoichi Asano, Wako-shi (JP); Ryoichiro Takahashi, Wako-shi (JP)

Correspondence Address: ARENT FOX KINTNER PLOTKIN & KAHN, PLLC, Suite 400, 1050 Connecticut Avenue, N.W., Washington, DC, 20036-5339, US

(73) Assignees: JSR Corporation; Honda Motor Co., Ltd.

(21) Appl. No.: 10/990,879

(22) Filed: Nov. 18, 2004

(30) Foreign Application Priority Data
Nov. 19, 2003 (JP) 2003-388776
Nov. 19, 2003 (JP) 2003-389478

(51) Int. Cl. H01M 6/18; H01M 8/10; C25B 13/00; C25C 7/04

(52) U.S. Cl. 429/313; 429/30; 429/33; 204/296

(57) ABSTRACT

A proton conductive membrane exhibiting superior proton conductivity even at high temperatures of 100° C. or above, and a proton conductive composition capable of forming the membrane are provided. The invention also provides a proton conductive membrane showing excellent proton conductivity even if it does not have an increased amount of the sulfonic groups introduced therein, and a proton conductive composition capable of forming the membrane. The proton conductive composition includes (a) at least one compound selected from a metal oxide hydrate, a phyllosilicate and a hygroscopic inorganic porous compound, and (b) a polyarylene having a sulfonic group.

### FIELD OF THE INVENTION

The present invention relates to a proton conductive membrane with improved proton conductivity suitable for use as a solid polymer electrolyte membrane in a solid polymer fuel cell, and to a composition for the membrane.

### BACKGROUND OF THE INVENTION

Recently, solid electrolytes are used more often than the conventional electrolyte (aqueous) solutions. This is because firstly those solid electrolytes have good processability in application in electric and electronic components, and secondly there are trends for overall size and weight reduction of such components and further for power saving.

Proton conductive materials comprising inorganic or organic compounds are known in the art. However, inorganic proton conductive compounds, such as uranyl phosphate hydrate, come with many difficulties when superposed as a conductive layer on a substrate or an electrode. For example, sufficient contact cannot be achieved in the interface between the conductive layer and the substrate or the like.

On the other hand, the organic proton conductive compounds include organic polymers that belong to the so-called cation exchange resins, for example sulfonated vinyl polymers such as polystyrene sulfonic acid; perfluoroalkylcarboxylic acid polymers and perfluoroalkylsulfonic acid polymers represented by Nafion® (DuPont); and polymers occurring by introducing sulfonic or phosphoric groups in heat resistant polymers such as polybenzimidazole and polyether ether ketone (Polymer Preprints, Japan, Vol. 42, No. 7, p. 2490-2492 (1993), Polymer Preprints, Japan, Vol. 43, No. 3, p. 735-736 (1994), Polymer Preprints, Japan, Vol. 42, No. 3, p. 730 (1993)).

These organic polymers are generally in the form of film when used as electrolytes. Their solvent solubility and thermoplasticity enable them to form a conductive membrane jointly on an electrode. However, many of the organic polymers are still insufficient in proton conductivity. In addition, they have poor service durability, reduce proton conductivity at high temperatures (100° C. or above), are embrittled by sulfonation to cause low mechanical strength, and have high moisture dependence. Moreover, the adhesion thereof with an electrode is not satisfactorily good. Further, because of the water-containing structure of these polymers, the conductive membranes are excessively swollen during operation, resulting in lowered strength and deformation. As described above, various problems are encountered in application of the organic polymers to electric and electronic components.

A fuel cell essentially consists of two catalyst electrodes and a solid electrolyte membrane sandwiched between the electrodes. Hydrogen, which is a fuel, is ionized at one of the electrodes, and the hydrogen ions diffuse through the solid electrolyte membrane and combine with oxygen at the other electrode. When the two electrodes are connected through an external circuit, electric current flows and electric power is supplied to the external circuit. Here, the solid electrolyte membrane has functions to diffuse the hydrogen ions, to physically isolate the fuel gas (hydrogen) and oxygen, and to block the flow of electrons.

The solid polymer electrolyte membranes include fluorine electrolyte membranes represented by perfluorocarbonsulfonic acid membranes proposed by DuPont, Dow Chemical Company, Asahi Kasei Corporation and Asahi Glass Co., Ltd. Due to excellent chemical stability, they are employed under severe conditions such as in fuel cells and water splitting.

However, the electrolyte membranes represented by the fluorine electrolyte membranes have a relatively low glass transition temperature, have a relatively weak hydration force because the sulfonic groups are ion sites, and are dried at or above the boiling point of water and at or below the saturated vapor pressure to reduce their proton conductance. Accordingly, the operating temperatures of the fuel cells including such electrolyte membranes are limited to 100° C. or below, and even worse to 80° C. or below.

Therefore, the electrolyte membranes such as the fluorine electrolyte membranes have special applications limited to solid polymer electrolyte fuel cells for space and military purposes. When such electrolyte membranes are applied to low-pollution automotive power sources, household small-size dispersed power sources and portable power sources, complicated systems are required for producing a hydrogen-based modified gas from a low molecular weight hydrocarbon as a raw fuel and for cooling the modified gas or removing carbon monoxide from the modified gas.

The electrode catalysts are more activated as the fuel cell is operated at higher temperatures, with the results that the electrode overvoltage is reduced and the carbon monoxide poisoning on the electrodes becomes minor. There is therefore a need for a solid polymer electrolyte membrane showing sufficient proton conductance at high temperatures (100° C. or above).

U.S. Pat. No. 5,403,675 discloses a solid polymer electrolyte comprising a sulfonated rigid-rod polyphenylene. This polymer mainly contains an aromatic compound composed of phenylene units and has been sulfonated by reaction with a sulfonating agent to introduce sulfonic groups therein. Although increasing the amount of the sulfonic groups introduced improves the proton conductance, it also causes the resultant sulfonated polymer to show remarkably deteriorated mechanical properties such as toughness, for example break elongation and folding endurance, and hot water resistance.

### OBJECTS OF THE INVENTION

It is an object of the invention to provide a proton conductive membrane exhibiting superior proton conductivity even at high temperatures of 100° C. or above, and to provide a proton conductive composition capable of forming the proton conductive membrane.

The invention has another object of providing a proton conductive membrane showing excellent proton conductivity even if it does not have an increased amount of the sulfonic groups introduced therein, and providing a proton conductive composition capable of forming the proton conductive membrane.

### DISCLOSURE OF THE INVENTION

The present inventors carried out earnest studies in view of the problems in the background art. As a result, it has been found that a proton conductive membrane exhibiting superior strength and proton conductivity even at high temperatures (100° C. or above) may be obtained by mixing and dispersing a specific additive within a proton conductive membrane to form a composite. The proton conductive membrane is capable of the above properties without an increased amount of the sulfonic groups introduced therein. The invention has been accomplished based on the finding.

To achieve the aforesaid objects, the invention provides the following proton conductive compositions and proton conductive membranes:

(1) A proton conductive composition comprising (a) at least one compound selected from a metal oxide hydrate, a phyllosilicate and a hygroscopic inorganic porous compound, and (b) a polyarylene having a sulfonic group.

(2) A proton conductive composition comprising (a-1) at least one compound selected from a metal oxide hydrate and a phyllosilicate, and (b) a polyarylene having a sulfonic group.

(3) The proton conductive composition as described in (1) or (2), wherein the metal oxide hydrate is at least one compound selected from the group consisting of tungsten oxide hydrate, tungsten oxide hydrate doped with niobium, tin oxide hydrate, silicon oxide hydrate, phosphorous oxide hydrate, silicon oxide hydrate doped with zirconia oxide hydrate, uranyl phosphate hydrate and molybdenum oxide hydrate.

(4) The proton conductive composition as described in (1) or (2), wherein the phyllosilicate is at least one compound selected from the group consisting of montmorillonite, saponite, hectorite, stevensite, vermiculite, fluorotetrasilicic mica and taeniolite.

(5) The proton conductive composition as described in (2), wherein the component (a-1) is contained in an amount of 0.5 to 80 parts by weight based on 100 parts by weight of the component (b).

(6) A proton conductive composition comprising (a-2) a hygroscopic inorganic porous compound and (b) a polyarylene having a sulfonic group.

(7) The proton conductive composition as described in (1) or (6), wherein the hygroscopic inorganic porous compound is at least one compound selected from the group consisting of silica, synthetic zeolite, particles in a titania, alumina, zirconia or yttria gel, and silica fibers.

(8) The proton conductive composition as described in (6), wherein the component (a-2) is contained in an amount of 0.01 to 60 parts by weight based on 100 parts by weight of the component (b).

(9) The proton conductive composition as described in any one of (1) to (8), wherein the polyarylene having a sulfonic group includes a structural unit represented by the following formula (A) and a structural unit represented by the following formula (B): 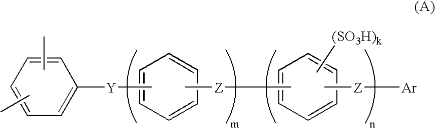
wherein Y is a divalent electron-withdrawing group; Z is a divalent electron-donating group or a direct bond; Ar is an aromatic group with a substituent —SO₃H; m is an integer of 0 to 10; n is an integer of 0 to 10; and k is an integer of 1 to 4; 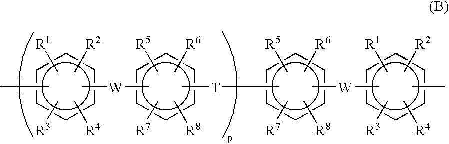
wherein R¹ to R⁸ may be the same or different and are each one or more atoms or groups selected from the group consisting of a hydrogen atom, a fluorine atom, an alkyl group, a fluorine-substituted alkyl group, an allyl group, an aryl group and a cyano group; W is a divalent electron-withdrawing group or a single bond; T is a divalent organic group or a single bond; and p is 0 or a positive integer.

(10) A proton conductive membrane comprising the proton conductive composition as described in any one of (1) to (9).

### EFFECTS OF THE INVENTION

The proton conductive compositions of the invention can give proton conductive membranes exhibiting superior proton conductivity even at high temperatures of 100° C. or above.

Furthermore, the proton conductive compositions of the invention can give proton conductive membranes showing excellent proton conductivity even if they do not have an increased amount of the sulfonic groups introduced therein.

### PREFERRED EMBODIMENTS OF THE INVENTION

Hereinbelow, the proton conductive compositions of the present invention and the proton conductive membranes comprising the compositions will be described in detail.

[Proton Conductive Compositions]

The first proton conductive composition according to the present invention comprises (a) at least one compound (hereinafter, the component (a)) selected from a metal oxide hydrate, a phyllosilicate and a hygroscopic inorganic porous compound, and (b) a polyarylene having a sulfonic group (hereinafter, the component (b)).

The second proton conductive composition comprises (a-1) at least one compound (hereinafter, the component (a-1)) selected from a metal oxide hydrate and a phyllosilicate, and the component (b).

The third proton conductive composition comprises (a-2) a hygroscopic inorganic porous compound (hereinafter, the component (a-2)) and the component (b).

(Metal Oxide Hydrate)

The metal oxide hydrate used in the present invention may be selected from the group consisting of tungsten oxide hydrate, tungsten oxide hydrate doped with niobium, tin oxide hydrate, silicon oxide hydrate, phosphorous oxide hydrate, silicon oxide hydrate doped with zirconia oxide hydrate, uranyl phosphate hydrate and molybdenum oxide hydrate. These compounds may be used either individually or in combination of two or more kinds.

Proton conductivity of the metal oxide hydrate is desirably at least 10⁻⁵ S/cm, and preferably at least 10⁻³ S/cm. When the proton conductivity is less than 10⁻⁵ S/cm, the proton conductance at 100° C. or above may be insufficient.

The metal oxide hydrate desirably has an average particle diameter of 100 nm or less, and preferably 80 nm or less. When the average particle diameter exceeds 100 nm, uniform dispersion of the particles within the proton conductive membrane becomes difficult.

The use of the above-described metal oxide hydrate leads to the proton conductive membrane capable of sufficient proton conductance even at 100° C. or above.

(Phyllosilicate)

The phyllosilicates for use in the present invention include montmorillonite, saponite, hectorite, stevensite, vermiculite, fluorotetrasilicic mica and taeniolite. The use of such phyllosilicates leads to the proton conductive membrane capable of sufficient proton conductance even at 100° C. or above.

In the proton conductive composition, the component (a-1) is preferably contained in an amount of 0.5 to 80 parts by weight, and more preferably 3 to 30 parts by weight based on 100 parts by weight of the component (b). When the amount of the component (a-1) is less than the above range, the proton conductance at high temperatures may be insufficient. When it exceeds the above range, the proton conductive membrane will be less flexible and have lowered adhesion to the electrodes, resulting in difficult assembly.

(Hygroscopic Inorganic Porous Compound)

The hygroscopic inorganic porous compound used in the invention may be selected from the group consisting of silica, synthetic zeolite, titania gel, alumina gel, zirconia gel, yttria gel and silica fibers. These compounds may be used either individually or in combination of two or more kinds.

Specific surface area of the hygroscopic inorganic porous compound is desirably from 10 to 1500 m²/g, and preferably from 50 to 900 m²/g. This specific surface area ensures a sufficient amount of water entrapped for enhancing proton transport through the proton conductive membrane, so that the proton conductance improves. The specific surface area is a value obtained by BET adsorption isotherm.

The hygroscopic inorganic porous particles desirably have an average particle diameter of 40 μm or less, preferably 10 μm or less, and more preferably 0.1 μm or less. When the average particle diameter is in the above range, the particles may be uniformly dispersed within the proton conductive membrane. When the hygroscopic inorganic porous particles are silica fibers, the fibers desirably have a thickness of 10 μm or less, and preferably 5 μm or less. The average particle diameter is obtained from particle diameters measured by, for example, a Coulter counter.

In the proton conductive composition, the component (a-2) is desirably contained in an amount of 0.01 to 60 parts by weight, and preferably 3 to 30 parts by weight based on 100 parts by weight of the component (b). When the amount of the component (a-2) is less than the above range, water retention for higher proton conductance may not reach a sufficient level. If the amount exceeds the above range, the proton conductance is likely to lower because of proton nonconductivity of the hygroscopic inorganic porous compound, although adequate water retention can be obtained.

(Polyarylene having a Sulfonic Group)

The polyarylene having a sulfonic group for use in the present invention is a polymer represented by the formula (C) given below. The polymer includes a structural unit of the following formula (A) and a structural unit of the following formula (B):

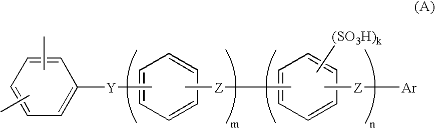

In the formula (A), Y is a divalent electron-withdrawing group such as —CO—, —SO₂—, —SO—, —CONH—, —COO—, —(CF₂)₁— (where 1 is an integer of 1 to 10) and —C(CF₃)₂—; and
Z is a direct bond or a divalent electron-donating group such as —(CH₂)—, —C(CH₃)₂—, —O—, —S—, —CH═CH—, —C≡C— and groups represented by:

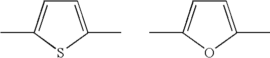

The electron-withdrawing group is defined as having a Hammett substituent constant of not less than 0.06 at the m-position and not less than 0.01 at the p-position of the phenyl group.

Ar denotes an aromatic group with a substituent —SO₃H. Exemplary aromatic groups include phenyl, naphthyl, anthryl and phenanthryl groups, with the phenyl and naphthyl groups being preferred.

In the formula (A), m is an integer of 0 to 10, preferably 0 to 2; n is an integer of 0 to 10, preferably 0 to 2; and k is an integer of 1 to 4.

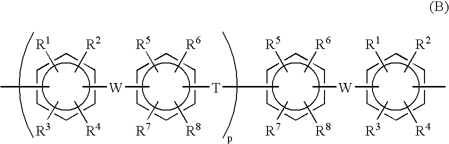

In the formula (B), R¹ to R⁸ may be the same or different and are each one or more atoms or groups selected from the group consisting of a hydrogen atom, a fluorine atom, an alkyl group, a fluorine-substituted alkyl group, an allyl group, an aryl group and a cyano group.

The alkyl groups include methyl, ethyl, propyl, butyl, amyl and hexyl groups, with the methyl and ethyl groups being preferred.

The fluorine-substituted alkyl groups include trifluoromethyl, perfluoroethyl, perfluoropropyl, perfluorobutyl, perfluoropentyl and perfluorohexyl groups, with the trifluoromethyl and perfluoroethyl groups being preferred.

The allyl groups include propenyl group.

The aryl groups include phenyl and pentafluorophenyl groups.

W is a divalent electron-withdrawing group or a single bond, T is a divalent organic group or a single bond, and p is 0 or a positive integer generally up to 100 and is preferably from 10 to 80.

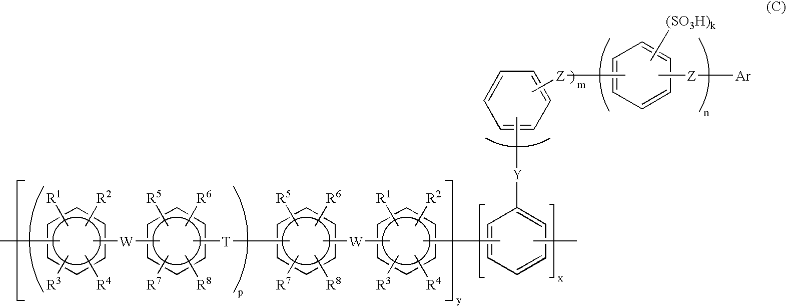

In the formula (C), W, T, Y, Z, Ar, m, n, k, p and R¹ to R⁸ are as described in the formulae (A) and (B), and x and y indicate a molar ratio such that x+y=100 mol %.

The polyarylene having a sulfonic group contains 0.5 to 100 mol %, preferably 10 to 99.999 mol % the structural unit of the formula (A), and 99.5 to 0 mol %, preferably 90 to 0.001 mol % the structural unit of the formula (B).

The polyarylene having a sulfonic group may be synthesized by copolymerizing a monomer which has a sulfonate group and is capable of forming the structural unit of the formula (A) with an oligomer capable of forming the structural unit of the formula (B) to produce a polyarylene having a sulfonate group, and subsequently hydrolyzing the polyarylene to convert the sulfonate group into the sulfonic group.

Alternatively, the polyarylene having a sulfonic group may be synthesized by sulfonating a polyarylene that includes the structural unit represented by the formula (A) except that it has no sulfonic or sulfonate groups and the structural unit represented by the formula (B).

The monomers capable of forming the structural unit of the formula (A) include sulfonates represented by the following formula (D) (hereinafter, the monomer (D)):

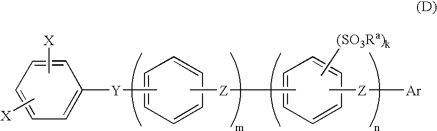

In the formula (D), X denotes a halogen atom other than fluorine (i.e., chlorine, bromine or iodine) or a —OSO₂G group (where G is an alkyl, fluorine-substituted alkyl or aryl group), and Y, Z, m, n and k are as described in the formula (A).

R^{a} denotes a hydrocarbon group of 1 to 20, and preferably 4 to 20 carbon atoms. Specific examples thereof include linear hydrocarbon groups, branched hydrocarbon groups, alicyclic hydrocarbon groups and 5-membered heterocyclic ring hydrocarbon groups, such as methyl, ethyl, n-propyl, iso-propyl, tert-butyl, iso-butyl, n-butyl, sec-butyl, neopentyl, cyclopentyl, hexyl, cyclohexyl, cyclopentylmethyl, cyclohexylmethyl, adamantyl, adamantanemethyl, 2-ethylhexyl, bicyclo[2.2.1]heptyl, bicyclo[2.2.1]heptylmethyl, tetrahydrofurfuryl, 2-methylbutyl, 3,3-dimethyl-2,4-dioxolanemethyl, cyclohexylmethyl and adamantylmethyl groups. Of these groups, the n-butyl, neopentyl, tetrahydrofurfuryl, cyclopentyl, cyclohexyl, cyclohexylmethyl, adamantylmethyl and bicyclo[2.2.1]heptylmethyl groups are preferred, and the neopentyl group is particularly preferable.

Ar denotes an aromatic group with a substituent —SO₃R^{b}. Exemplary aromatic groups include phenyl, naphthyl, anthryl and phenanthryl groups, with the phenyl and naphthyl groups being preferred.

The aromatic group is substituted with one or more of the substituents —SO₃R^{b}. When two or more substituents —SO₃R^{b} are present, they may be the same as or different from one another.

R^{b} denotes a hydrocarbon group of 1 to 20, and preferably 4 to 20 carbon atoms. Specific examples thereof include the above-described hydrocarbon groups having 1 to 20 carbon atoms. Of such groups, the n-butyl, neopentyl, tetrahydrofurfuryl, cyclopentyl, cyclohexyl, cyclohexylmethyl, adamantylmethyl and bicyclo[2.2.1]heptylmethyl groups are preferred, and the neopentyl group is particularly preferable.

Specific examples of the sulfonates represented by the formula (D) include compounds listed below:

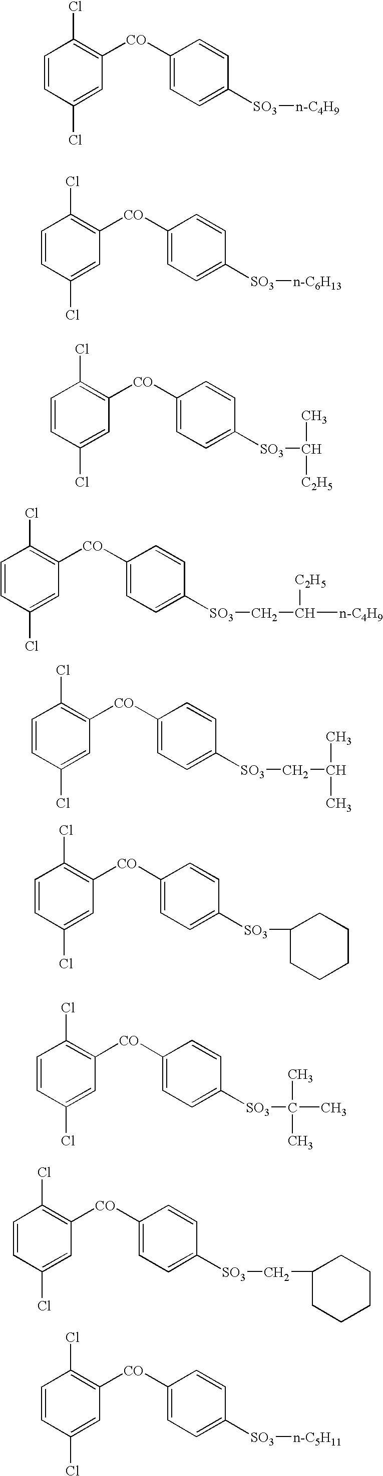

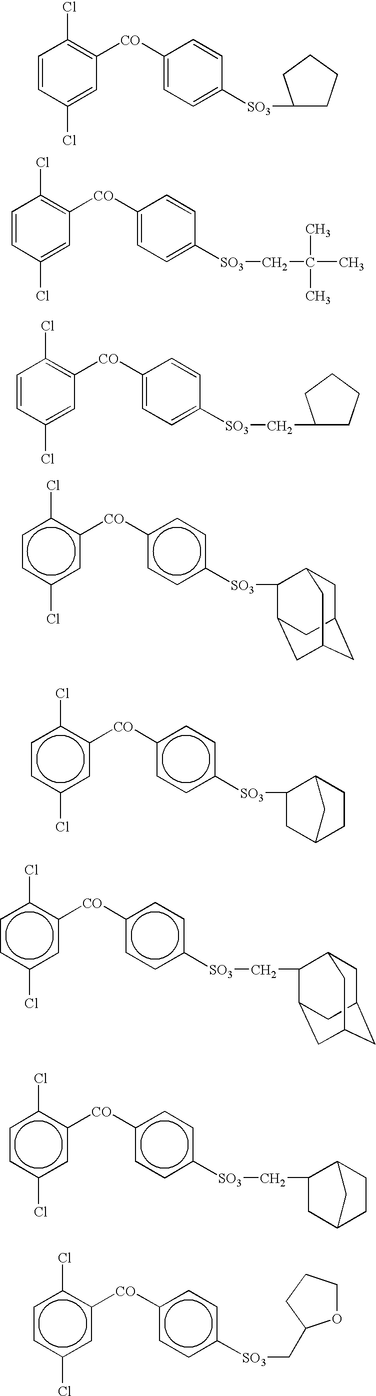

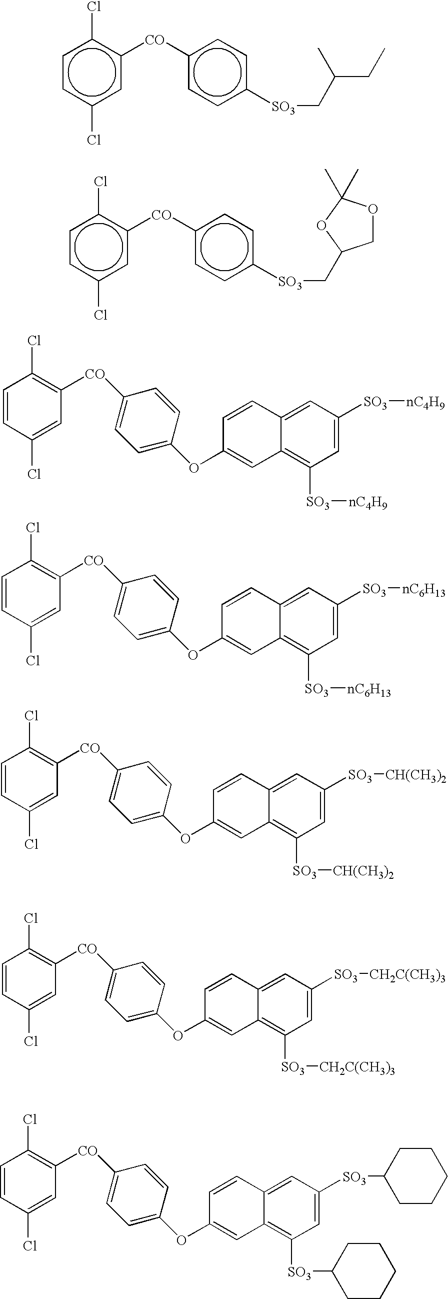

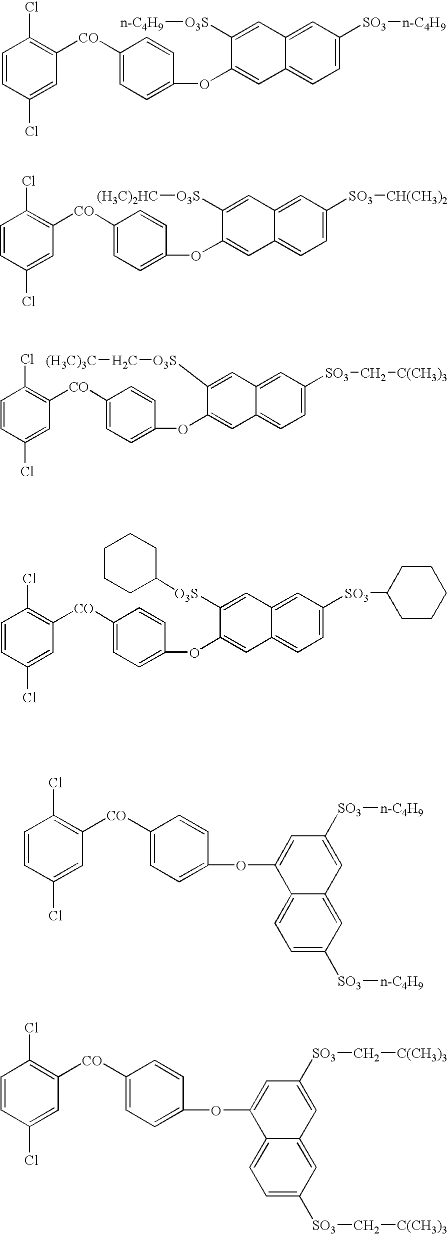

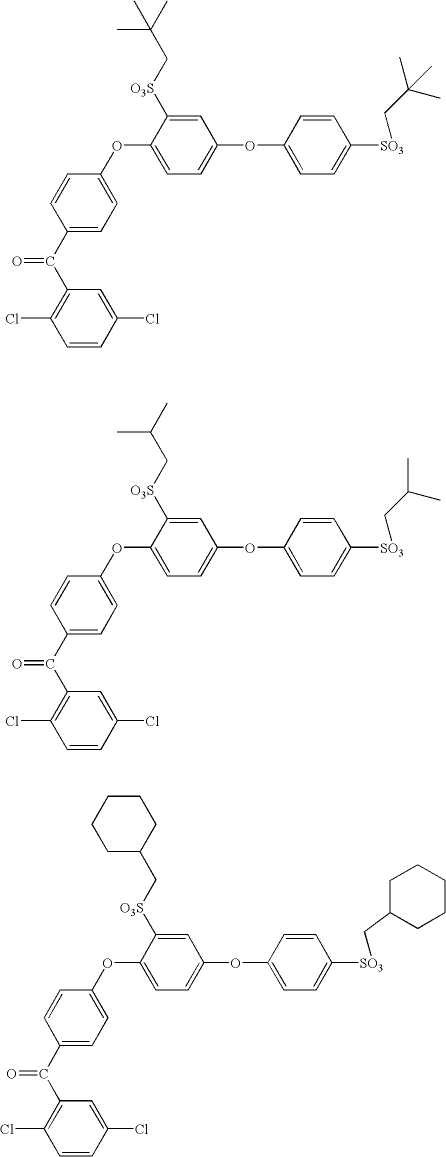

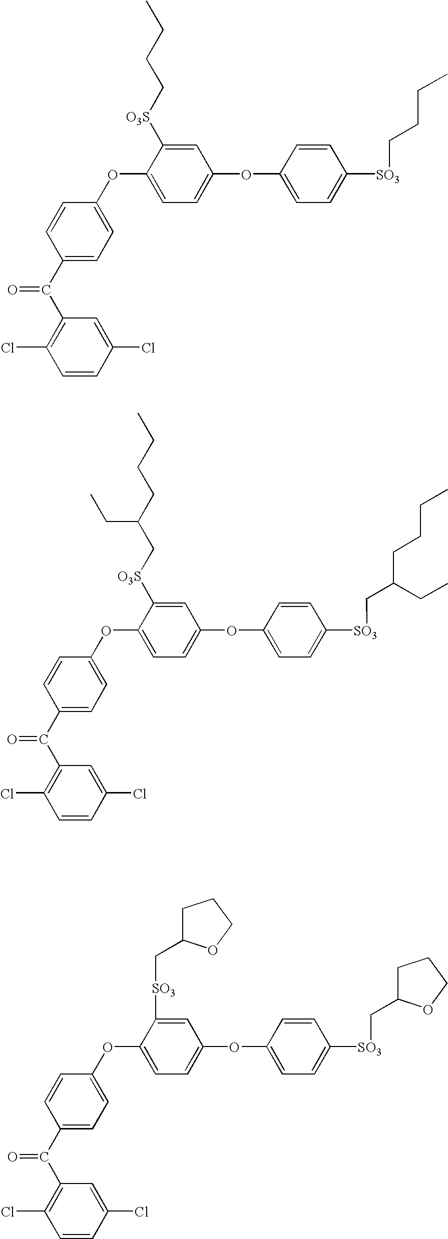

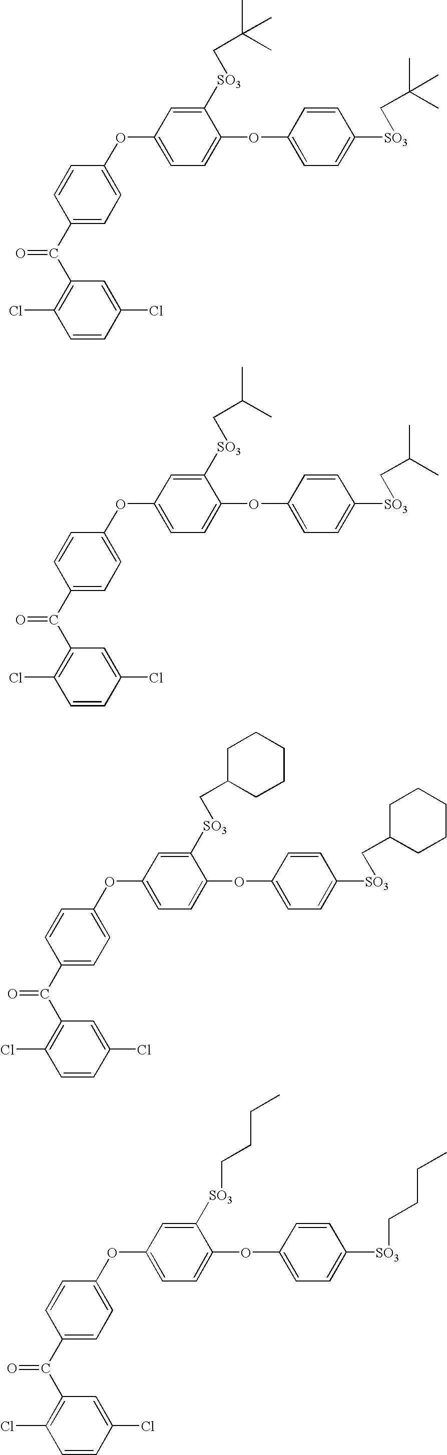

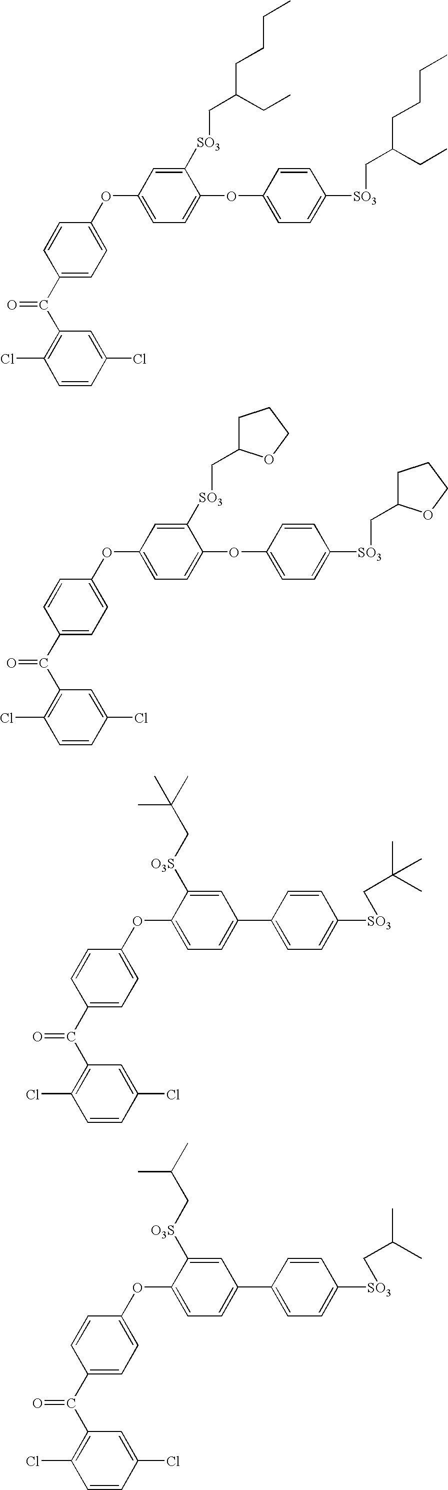

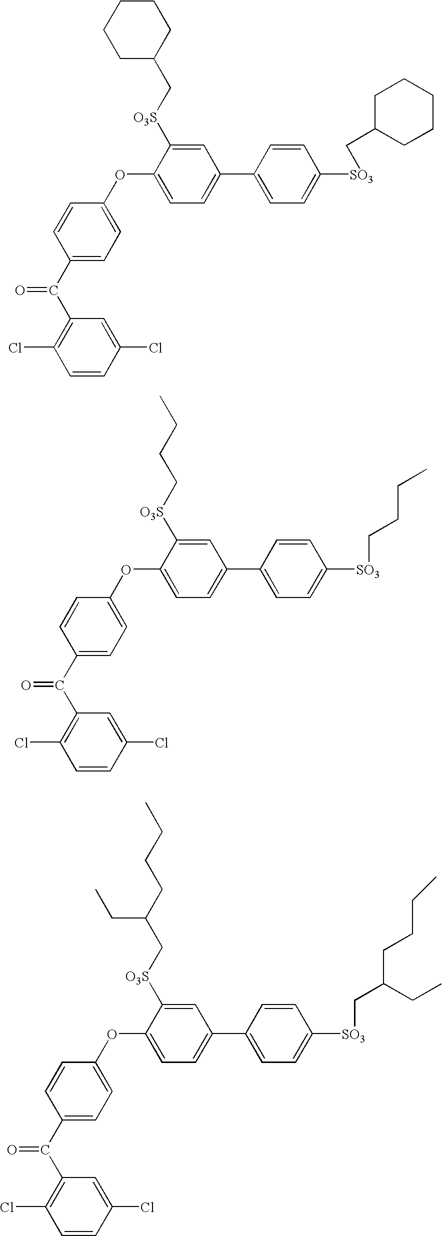

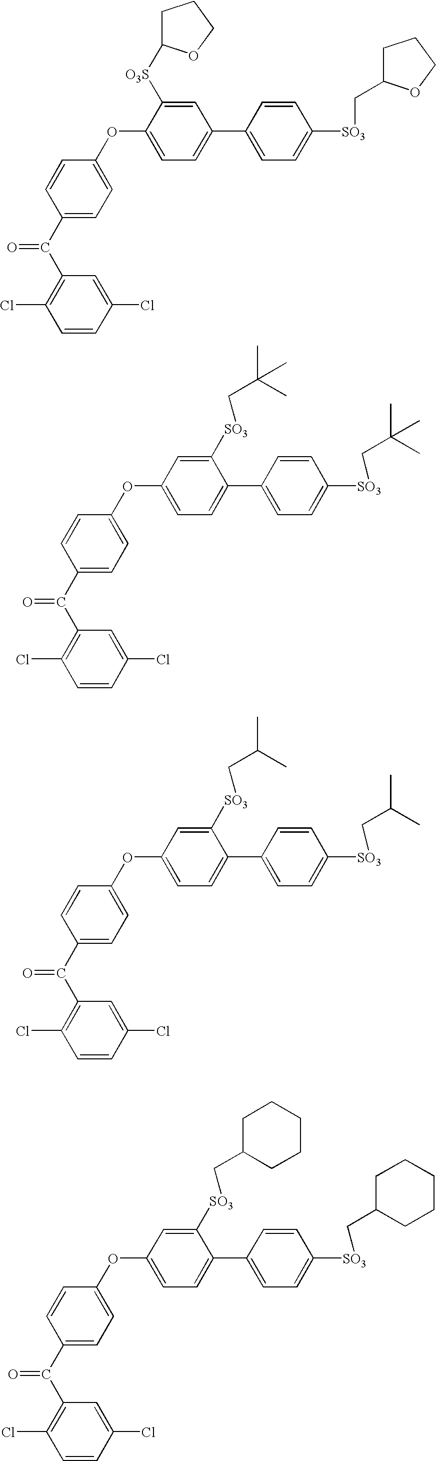

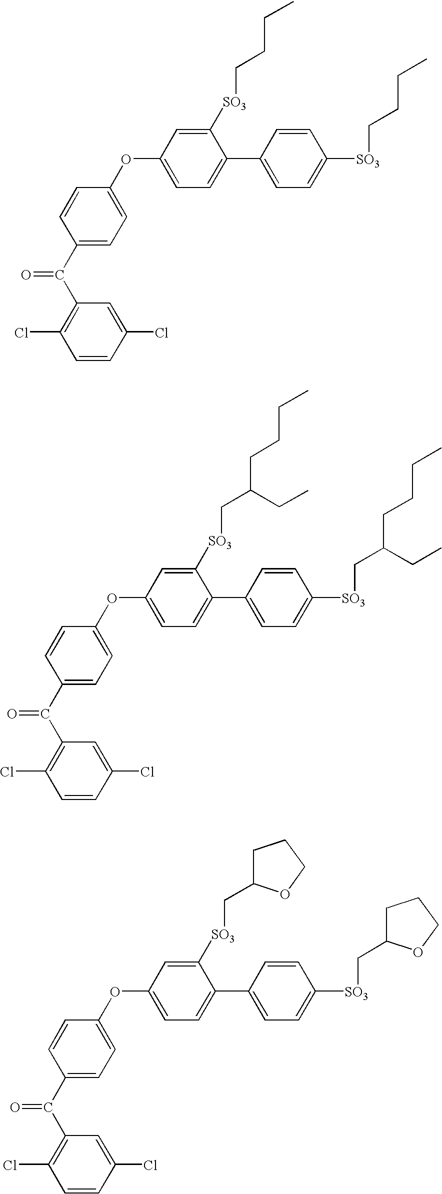

Also employable are aromatic sulfonate derivatives of the formula (D) that correspond to the above-illustrated compounds except that the chlorine atoms are replaced by bromine atoms, the —CO— group is replaced by the —SO₂— group, or these two replacements occur at the same time.

The R^{b} group in the formula (D) is preferably derived from a primary alcohol, and the β carbon atom is preferably tertiary or quaternary. More preferably, such ester group is derived from a primary alcohol and the β carbon atom is quaternary. When these two conditions are satisfied, excellent stability may be obtained during polymerization and no inhibited polymerization or crosslinking will result from the formation of sulfonic acids by deesterification.

The compounds represented by the formula (D) except having no sulfonic or sulfonate groups include the following compounds:

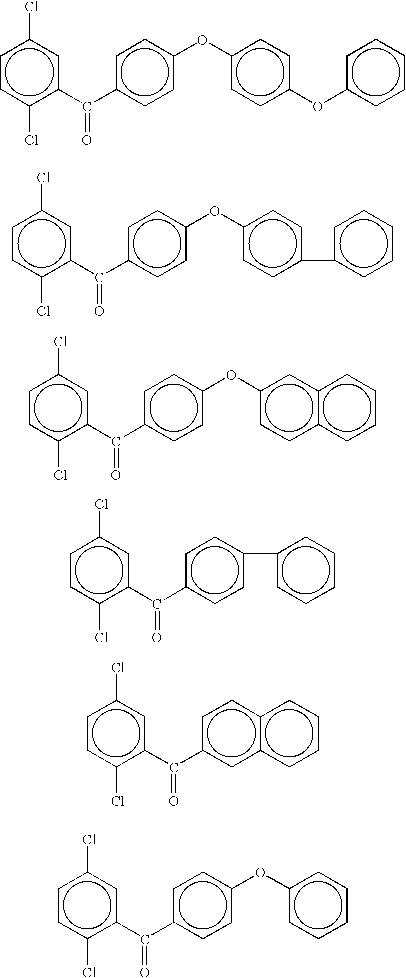

Also employable are compounds corresponding to the above compounds except that the chlorine atoms are replaced by bromine atoms, the —CO— group is replaced by the —SO₂— group, or these two replacements occur at the same time.

The oligomers capable of forming the structural unit of the formula (B) include oligomers represented by the following formula (E) (hereinafter, the oligomer(s) (E)):

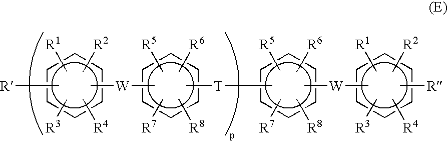

In the formula (E), R′ and R″ maybe the same or different and are each a halogen atom other than fluorine or a —OSO₂G group (where G is an alkyl, fluorine-substituted alkyl or aryl group), and R¹ to R⁸, W, T and p are as described in the formula (B). Indicated by G, the alkyl groups include methyl and ethyl groups, the fluorine-substituted alkyl groups include trifluoromethyl group, and the aryl groups include phenyl and p-tolyl groups.

Exemplary compounds of the formula (E) in which p is 0 include 4,4′-dichlorobenzophenone, 4,4′-dichlorobenzanilide, bis(chlorophenyl)difluoromethane, 2,2-bis(4-chlorophenyl)hexafluoropropane, 4-chlorobenzoic acid-4-chlorophenyl, bis(4-chlorophenyl)sulfoxide, bis(4-chlorophenyl)sulfone, 2,6-dichlorobenzonitrile, 9,9-bis (4-hydroxyphenyl)fluorene, corresponding compounds to these compounds except that the chlorine atom is replaced with a bromine or an iodine atom, and corresponding compounds to the above compounds except that at least one of the halogen atoms substituted at the 4-position is altered to a substituent at the 3-position.

Exemplary compounds of the formula (E) in which p is 1 include 4,4′-bis(4-chlorobenzoyl)diphenyl ether, 4,4′-bis(4-chlorobenzoylamino)diphenyl ether, 4,4′-bis(4-chlorophenylsulfonyl)diphenyl ether, 4,4′-bis(4-chlorophenyl)diphenyl ether dicarboxylate, 4,4′-bis[(4-chlorophenyl)-1,1,1,3,3,3-hexafluoropropyl]diphenyl ether, 4,4′-bis[(4-chlorophenyl)tetrafluoroethyl]diphenyl ether, corresponding compounds to these compounds except that the chlorine atom is replaced with a bromine or an iodine atom, corresponding compounds to the above compounds except that the halogen substitution occurs at the 3-position in place of the 4-position, and corresponding compounds to the above compounds except that at least one of the substituent groups at the 4-position in the diphenyl ether is altered to a substituent at the 3-position.

The compounds of the formula (E) further include 2,2-bis[4-{4-(4-chlorobenzoyl)phenoxy}phenyl]-1,1,1,3,3,3-hexafluoropropane, bis[4-{4-(4-chlorobenzoyl)phenoxy}phenyl]sulfone, and compounds represented by the following formulae:

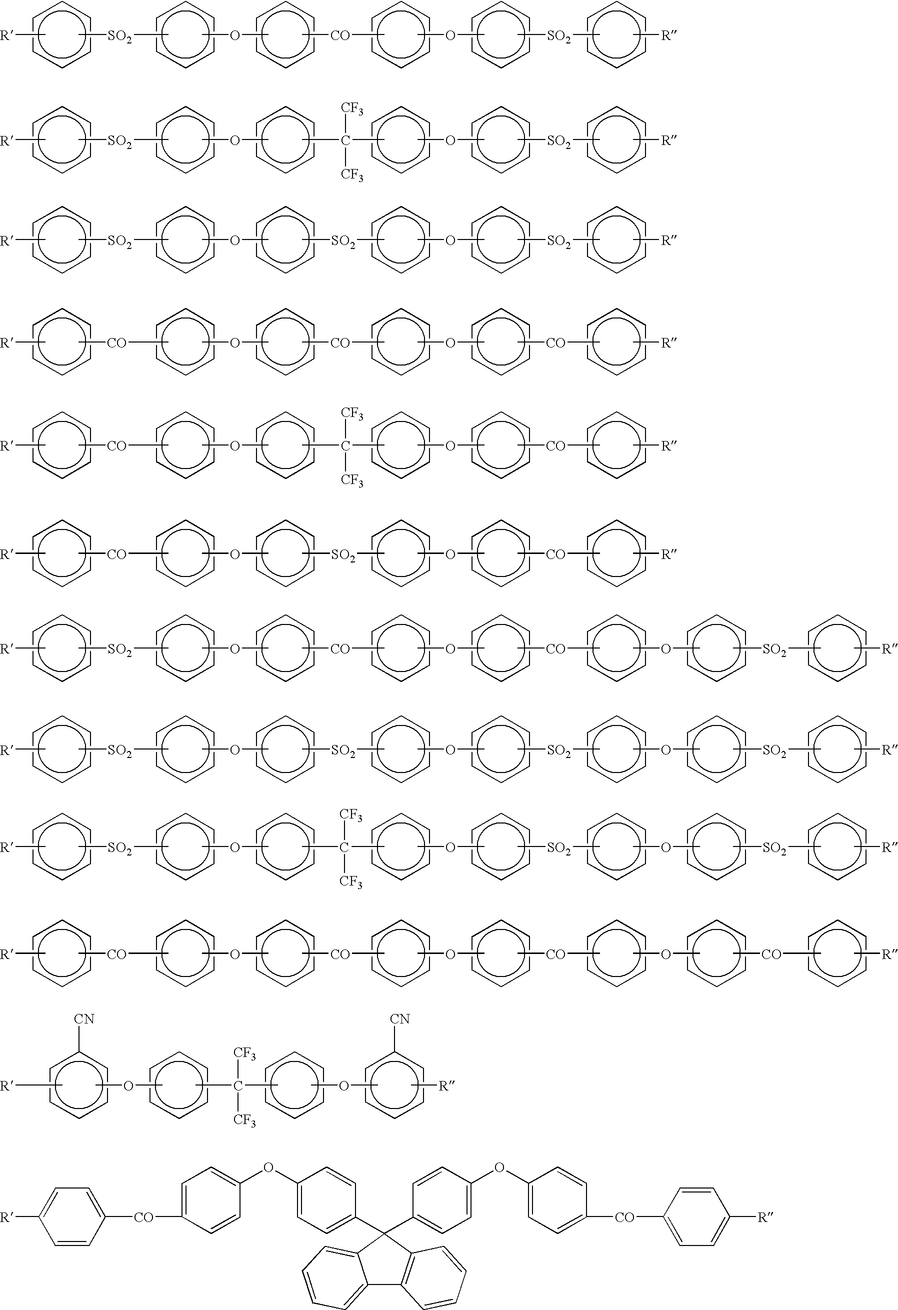

For example, the compound represented by the formula (E) may be synthesized by the process given below.

First, an alkali metal such as lithium, sodium or potassium, or an alkali metal compound such as an alkali metal hydride, an alkali metal hydroxide or an alkali metal carbonate, is added to bisphenols combined together by the electron-withdrawing group thereby to convert them into a corresponding alkali metal salt of bisphenol. This reaction is made in a polar solvent of high dielectric constant, such as N-methyl-2-pyrrolidone, N,N-dimethylacetamide, sulfolane, diphenyl sulfone or dimethyl sulfoxide. The alkali metal will be generally used in slight excess over the hydroxyl groups of the bisphenol, for example 1.1 to 2 times, and preferably 1.2 to 1.5 times the equivalent weight of the hydroxyl groups.

Thereafter, the alkali metal salt of bisphenol is reacted with a halogen-substituted, e.g. fluorine- or chlorine-substituted, aromatic dihalide compound which has been activated by the electron-withdrawing groups, in the presence of a solvent that can form an azeotropic mixture with water, such as benzene, toluene, xylene, hexane, cyclohexane, octane, chlorobenzene, dioxane, tetrahydrofuran, anisole or phenetole. Examples of the above aromatic dihalide compound include 4,4′-difluorobenzophenone, 4,4′-dichlorobenzophenone, 4,4′-chlorofluorobenzophenone, bis(4-chlorophenyl)sulfone, bis(4-fluorophenyl)sulfone, 4-fluorophenyl-4′-chlorophenylsulfone, bis(3-nitro-4-chlorophenyl)sulfone, 2,6-dichlorobenzonitrile, 2,6-difluorobenzonitrile, hexafluorobenzene, decafluorobiphenyl, 2,5-difluorobenzophenone and 1,3-bis(4-chlorobenzoyl)benzene. From the viewpoint of reactivity, the aromatic dihalide compound is desirably a fluorine compound. But taking the subsequent aromatic coupling reaction into account, the aromatic nucleophilic substitution reaction should be designed to take place so as to yield a molecule having a chlorine atom at its end(s). The active aromatic dihalide compound may be used in an amount 2 to 4 times, and preferably 2.2 to 2.8 times the moles of the bisphenol. The reaction temperature is in the range of 60 to 300° C., and preferably 80 to 250° C. The reaction time ranges from 15 minutes to 100 hours, and preferably from 1 to 24 hours.

Optimally, the active aromatic dihalide compound is a chlorofluoro compound as shown in the formula below that has two halogen atoms different in reactivity from each other. The use of this compound is advantageous in that the fluorine atom will preferentially undergo the nucleophilic substitution reaction with phenoxide so that the objective chlorine-terminated active compound may be obtained. 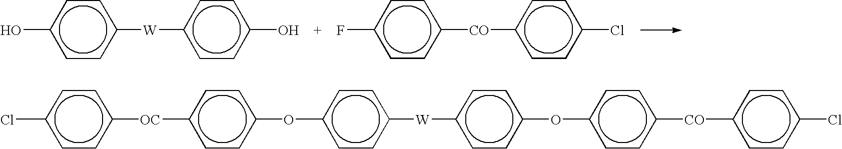
wherein W is as defined in the formula (B).

Alternatively, the nucleophilic substitution reaction may be carried out in combination with electrophilic substitution reaction to synthesize an objective flexible compound comprising the electron-withdrawing and electron-donating groups, as described in JP-A-H02-159.

Specifically, the aromatic bis-halide activated by the electron-withdrawing groups, such as bis(4-chlorophenyl)sulfone, is subjected to the nucleophilic substitution reaction with a phenol; thereafter the resultant bis-phenoxy compound is subjected to Friedel-Crafts reaction with, for example, 4-chlorobenzoyl chloride to give an objective compound.

The aromatic bis-halide activated by the electron-withdrawing groups used herein may be selected from the above-exemplified aromatic dihalide compounds. The phenol compound may be substituted, but is preferably unsubstituted from the viewpoints of heat resistance and flexibility. When substituted, the substituted phenol compound is preferably an alkali metal salt. Any of the alkali metal compounds listed above can be used in the substitution reaction for the phenol compound. The alkali metal compound may be used in an amount 1.2 to 2 times the mole of the phenol. In the reaction, the aforesaid polar solvent or the azeotropic solvent with water may be employed.

The chlorobenzoyl chloride is used in an amount 2 to 4 times, and preferably 2.2 to 3 times the moles of the bis-phenoxy compound. The Friedel-Crafts reaction between the bis-phenoxy compound and the acylating agent chlorobenzoyl chloride is preferably carried out in the presence of an activator for the Friedel-Crafts reaction, such as aluminum chloride, boron trifluoride or zinc chloride. The Friedel-Crafts reaction activator is used in an amount 1.1 to 2 times the moles of the active halide compound such as the acylating agent chlorobenzoic acid. The reaction time is in the range of 15 minutes to 10 hours, and the reaction temperature is in the range of −20 to 80° C. As a solvent, chlorobenzene, nitrobenzene or the like that is inactive in the Friedel-crafts reaction may be used.

The compound of the formula (E) in which p is 2 or greater can be prepared by the substitution reaction of a bisphenol alkali metal salt with an excess amount of the activated aromatic halogen compound in the presence of a polar solvent such as N-methyl-2-pyrrolidone, N,N-dimethylacetoamide or sulfolane in accordance with the above monomer synthesis procedure. In this case, the bisphenol is a compound which can supply ether oxygen as the electron-donating group T and at least one group selected from >C═O, —SO₂— and >C(CF₃)₂ as the electron-withdrawing groups W in the formula (E). Examples of the bisphenol may include 2,2-bis(4-hydroxyphenyl)-1,1,1,3,3,3-hexafluoropropane, 2,2-bis(4-hydroxyphenyl)ketone, 2,2-bis(4-hydroxyphenyl)sulfone, etc. Examples of the activated aromatic halogen compound may include 4,4-dichlorobenzophenone, bis(4-chlorophenyl)sulfone, etc.

Examples of such compounds include those represented by the following formulae:

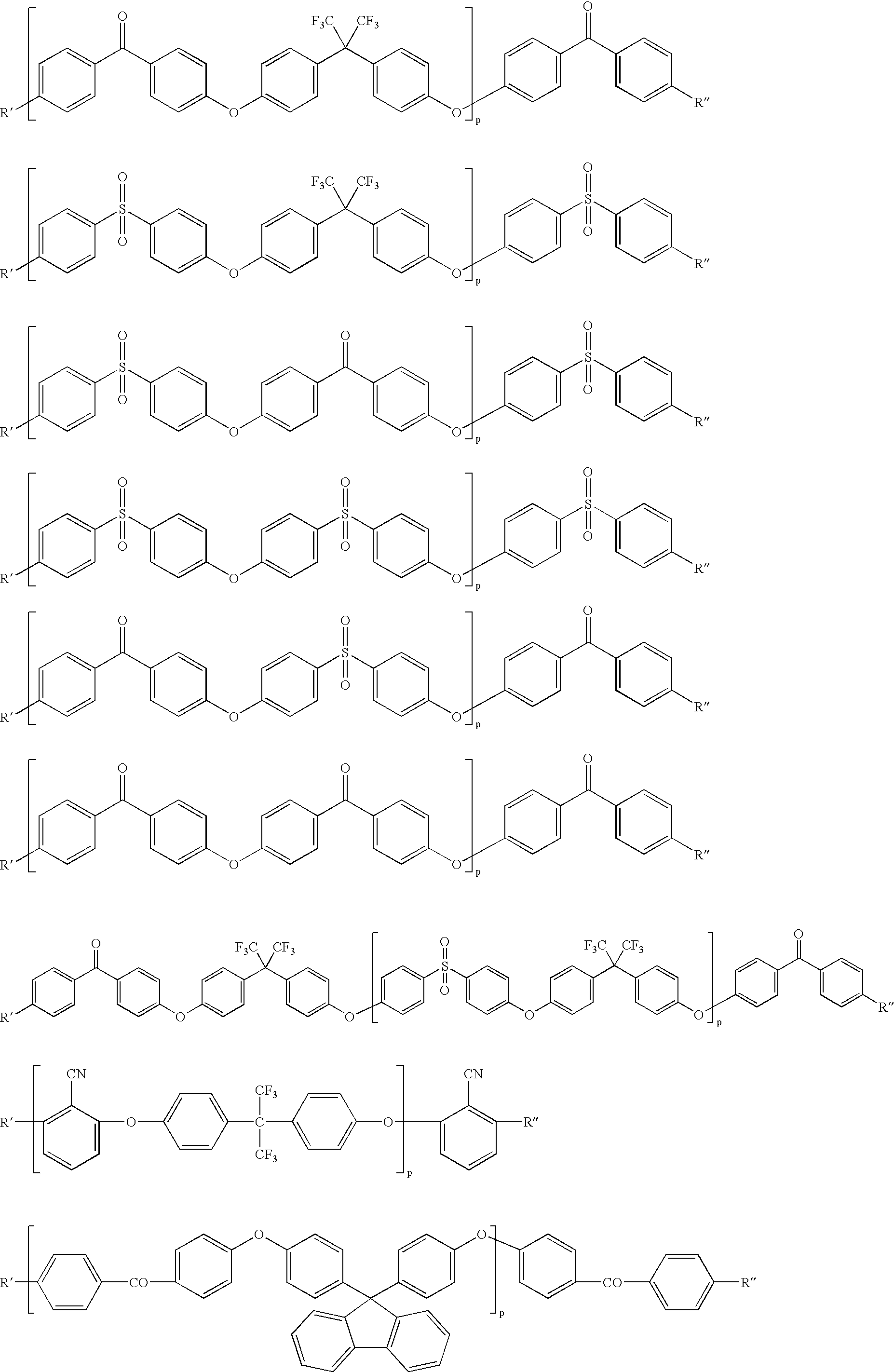

To synthesize the polyarylene having a sulfonate group, the monomer (D) and the oligomer (E) are reacted in the presence of a catalyst. The catalyst used herein is a catalyst system containing a transition metal compound. This catalyst system essentially contains (1) a transition metal salt and a compound which functions as a ligand (referred to as the “ligand component” hereinafter), or a transition metal complex (including a copper salt) to which ligands are coordinated, and (2) a reducing agent. A “salt” may be added to increase the polymerization rate.

Examples of the transition metal salt include nickel compounds such as nickel chloride, nickel bromide, nickel iodide and nickel acetylacetonate; palladium compounds such as palladium chloride, palladium bromide and palladium iodide; iron compounds such as iron chloride, iron bromide and iron iodide; and cobalt compounds such as cobalt chloride, cobalt bromide and cobalt iodide. Of these, nickel chloride and nickel bromide are particularly preferred.

Examples of the ligand component include triphenylphosphine, 2,2′-bipyridine, 1,5-cyclooctadiene and 1,3-bis(diphenylphosphino)propane. Of these, triphenylphosphine and 2,2′-bipyridine are preferred. The ligand components may be used either singly or in combination of two or more kinds.

Examples of the transition metal complex with coordinated ligands include nickel chloride-bis(triphenylphosphine), nickel bromide-bis(triphenylphosphine), nickel iodide-bis(triphenylphosphine), nickel nitrate-bis(triphenylphosphine), nickel chloride(2,2′-bipyridine), nickel bromide(2,2′-bipyridine), nickel iodide(2,2′-bipyridine), nickel nitrate(2,2′-bipyridine), bis(1,5-cyclooctadiene)nickel, tetrakis(triphenylphosphine)nickel, tetrakis(triphenylphosphito)nickel and tetrakis(triphenylphosphine)palladium. Of these, nickel chloride-bis(triphenylphosphine) and nickel chloride(2,2′-bipyridine) are preferred.

Examples of the reducing agent employable in the aforesaid catalyst system include iron, zinc, manganese, aluminum, magnesium, sodium and calcium. Of these, zinc, magnesium and manganese are preferable. These reducing agents may be used in a more activated form by being contacted with an acid such as an organic acid.

Examples of the “salt” employable in the catalyst system include sodium compounds such as sodium fluoride, sodium chloride, sodium bromide, sodium iodide and sodium sulfate; potassium compounds such as potassium fluoride, potassium chloride, potassium bromide, potassium iodide and potassium sulfate; and ammonium compounds such as tetraethylammonium fluoride, tetraethylammonium chloride, tetraethylammonium bromide, tetraethylammonium iodide and tetraethylammonium sulfate. Of these, sodium bromide, sodium iodide, potassium bromide, tetraethylammonium bromide and tetraethylammonium iodide are preferred.

In respect of the proportion of the above components, the transition metal salt or the transition metal complex is usually used in an amount of 0.0001 to 10 mol, and preferably 0.01 to 0.5 mol per mol of the monomers combined ((D)+(E), the same applies hereinafter). If the amount is less than 0.0001 mol, the polymerization may not proceed sufficiently. Contrary, the amount exceeding 10 mol may result in a lowered molecular weight of the polyarylene.

When the catalyst system contains the transition metal salt and the ligand component, the ligand component usually has an amount of 0.1 to 100 mol, and preferably 1 to 10 mol per mol of the transition metal salt. If the amount is less than 0.1 mol, the catalytic activity may become insufficient. Contrary, the amount exceeding 100 mol may result in a lowered molecular weight of the polyarylene.

The amount of the reducing agent is usually in the range of 0.1 to 100 mol, and preferably 1 to 10 mol per mol of the monomers combined. If the reducing agent is used in an amount less than 0.1 mol, the polymerization may not proceed sufficiently. Contrary, the amount thereof exceeding 100 mol may lead to difficult purification of the resulting polymer.

When the “salt” is used, the amount thereof is usually 0.001 to 100 mol, and preferably 0.01 to 1 mol per mol of the monomers combined. If the salt is used in an amount less than 0.001 mol, an effect of increasing the polymerization rate is often insufficient. Contrary, the amount thereof exceeding 100 mol may result in difficult purification of the resulting polymer.

Suitable polymerization solvents for use in the reaction between the monomer (D) and the oligomer (E) include tetrahydrofuran, cyclohexanone, dimethyl sulfoxide, N,N-dimethylformamide, N,N-dimethylacetamide, N-methyl-2-pyrrolidone, γ-butyrolactone and N,N′-dimethylimidazolidinone. Of these, tetrahydrofuran, N,N-dimethylformamide, N,N-dimethylacetamide, N-methyl-2-pyrrolidone and N,N′-dimethylimidazolidinone are preferred. These polymerization solvents are desirably used after dried sufficiently.

The concentration of all the monomers combined in the polymerization solvent is usually in the range of 1 to 90 wt%, and preferably 5 to 40 wt %.

The polymerization can usually be carried out at 0 to 200° C., and preferably 50 to 120° C., and over a period of 0.5 to 100 hours, and preferably 1 to 40 hours.

The polyarylene having a sulfonate group derived from the monomer (D) will be subjected to hydrolysis to convert the sulfonate group into the sulfonic group, thereby obtaining the polyarylene having a sulfonic group.

For example, the hydrolysis may be performed by any of the following methods:

(1) The polyarylene with a sulfonate group is added to an excess of water or an alcohol that contains a little hydrochloric acid, and the mixture is stirred for at least 5 minutes.

(2) The polyarylene with a sulfonate group is reacted in trifluoroacetic acid at about 80 to 120° C. for about 5 to 10 hours.

(3) The polyarylene with a sulfonate group is reacted in a solution such as N-methylpyrrolidone that contains lithium bromide in an amount 1 to 3 times the moles of the sulfonate groups (—SO₃R) of the polyarylene, at about 80 to 150° C. for about 3 to 10 hours, and thereafter hydrochloric acid is added to the reaction product.

Alternatively, the polyarylene having a sulfonic group may be obtained by copolymerizing a monomer of the formula (D) except having no sulfonate groups with the oligomer (E) of the formula (E), and sulfonating the thus-synthesized polyarylene copolymer. Specifically, a polyarylene having no sulfonic group is produced by the above-described procedure and treated with a sulfonating agent to introduce a sulfonic group in the polyarylene. The polyarylene having a sulfonic group may be thus obtained.

The sulfonation may be performed by treating the polyarylene having no sulfonic group with a conventional sulfonating agent, such as sulfuric anhydride, fuming sulfuric acid, chlorosulfonic acid, sulfuric acid or sodium bisulfite, in the absence or presence of a solvent according under known conditions. (See Polymer Preprints, Japan, vol. 42, No. 3, p. 730 (1993), Polymer Preprints, Japan, vol. 43, No. 3, p. 736 (1994), and Polymer Preprints, Japan, vol. 42, No. 7, pp. 2490-2492 (1993).)

The solvents used herein include hydrocarbon solvents such as n-hexane; ether solvents such as tetrahydrofuran and dioxane; aprotic polar solvents such as dimethylacetamide, dimethylformamide and dimethyl sulfoxide; and halogenated hydrocarbons such as tetrachloroethane, dichloroethane, chloroform and methylene chloride. The reaction temperature is not particularly limited, but is usually in the range of −50 to 200° C., and preferably −10 to 100° C. The reaction time is usually 0.5 to 1,000 hours, and preferably 1 to 200 hours.

The thus-produced polyarylene (C) having a sulfonic group will generally contain the sulfonic groups in an amount of 0.3 to 5 meq/g, preferably 0.5 to 3 meq/g, and more preferably 0.8 to 2.8 meq/g. If the sulfonic group content is less than 0.3 meq/g, the proton conductance will not reach a practical level. Contrary, when it exceeds 5 meq/g, water resistance will be drastically deteriorated.

The sulfonic group content may be manipulated by changing the types, amounts and combination of the monomer (D) and the oligomer (E).

The polyarylene having a sulfonic group has a weight-average molecular weight of 10,000 to 1,000,000, and preferably 20,000 to 800,000, as measured by gel permeation chromatography (GPC) in terms of polystyrene.

The polyarylene having a sulfonic group may contain an anti-aging agent, preferably a hindered phenol compound with a molecular weight of not less than 500. Such anti-aging agents provide longer durability of the electrolyte.

The hindered phenol compounds employable in the invention include
triethyleneglycol-bis[3-(3-t-butyl-5-methyl-4-hydroxyphenyl)propionate] (trade name: IRGANOX 245),
1,6-hexanediol-bis[3-(3,5-di-t-butyl-4-hydroxyphenyl)propionate] (trade name: IRGANOX 259), 2,4-bis-(n-octylthio)-6-(4-hydroxy-3,5-di-t-butylanilino)-3,5-triadine (trade name: IRGANOX 565), pentaerythrithyl-tetrakis[3-(3,5-di-t-butyl-4-hydroxyphenyl)propionate] (trade name: IRGANOX 1010), 2,2-thio-diethylene-bis[3-(3,5-di-t-butyl-4-hydroxyphenyl)propionate] (trade name: IRGANOX 1035), octadecyl-3-(3,5-di-t-butyl-4-hydroxyphenyl)propionate] (trade name: IRGANOX 1076), N,N-hexamethylenebis (3,5-di-t-butyl-4-hydroxy-hydrocinnamide) (trade name: IRGANOX 1098), 1,3,5-trimethyl-2,4,6-tris(3,5-di-t-butyl-4-hydroxybenzyl)benzene (trade name: IRGANOX 1330), tris-(3,5-di-t-butyl-4-hydroxybenzyl)-isocyanurate (trade name: IRGANOX 3114) and 3,9-bis[2-[3-(3-t-butyl-4-hydroxy-5-methylphenyl)propionyloxy]-1,1-dimethylethyl]-2,4,8,10-tetraoxaspiro[5.5]undecane (trade name: Sumilizer GA-80).

The hindered phenol compound will preferably be used in an amount of 0.01 to 10 parts by weight based on 100 parts by weight of the polyarylene having a sulfonic group.

In addition to the metal oxide hydrate, the phyllosilicate, the hygroscopic inorganic porous compound and the polyarylene having a sulfonic group, the proton conductive compositions of the invention may contain inorganic acids such as sulfuric and phosphoric acids, organic acids including carboxylic acids, an appropriate amount of water, and the like.

The proton conductive composition may be prepared by mixing the aforesaid components in a predetermined ratio by means of a conventional high-shear mixer, such as a homogenizer, a disperser, a paint conditioner or a ball mill. A solvent may be optionally used in the mixing. When the component (a) is incorporated in the solid polymer electrolyte, the component (a) is preferably mixed in the form of dispersion or solution in a hydrophilic solvent because it can be incorporated within the solid polymer electrolyte with ease near the ion exchange groups.

[Proton Conductive Membrane]

The proton conductive membrane according to the present invention comprises any of the aforesaid proton conductive compositions. For example, the proton conductive membrane may be produced by a casting method in which the proton conductive composition is cast over a substrate to form a film.

The substrate used herein may be a polyethyleneterephthalate (PET) film, but is not particularly limited thereto. Any substrates commonly used in the solution casting methods may be employed. Examples include plastic substrates and metal substrates.

Although the concentration of the polyarylene having a sulfonic group in the solution (i.e. the polymer concentration) depends on the molecular weight of the polyarylene, it is generally from 5 to 40 wt %, and preferably from 7 to 25 wt %. The polymer concentration less than 5 wt % causes difficulties in producing the membrane in large thickness and results in easy occurrence of pinholes. On the other hand, when the polymer concentration goes over 40 wt %, the solution viscosity becomes so high that the film production will be difficult and further that the obtained membrane often has low surface smoothness.

The solution viscosity may vary depending on the molecular weight of the polyarylene or the solid concentration. Generally, it ranges from 2,000 to 100,000 mPa.s, and preferably from 3,000 to 50,000 mPa.s. When the viscosity is less than 2,000 mPa.s, the solution will have too high a fluidity and may spill out of the substrate during the membrane production. On the contrary, the viscosity over 100,000 mPa.s is so high that the solution cannot be extruded through a die and the film-casting becomes difficult.

The coating formed by the casting method is dried at 30 to 160° C., preferably 50 to 150° C., for 3 to 180 minutes, preferably for 5 to 120 minutes to give a film. The dry thickness of the film will generally range from 10 to 100 μm, and preferably from 20 to 80 μm.

When the proton conductive membrane contains the component (a), the membrane can have a desirable minimum thickness because of the presence of such components. Accordingly, it becomes less likely that the electrodes will penetrate the membrane during production of an electrode-membrane assembly or during operation of a fuel cell, preventing a short circuit between the electrodes. Therefore, the thickness of the proton conductive membrane can be appropriately reduced. Further, the proton conductive membrane with a reduced thickness has lower resistivity, which in combination with the enhanced water retention by addition of the component (a) will lead to higher output characteristics.

The solvent for use in the casting method is not particularly limited. Exemplary solvents include aprotic polar solvents such as γ-butyrolactone, dimethylacetamide, dimethylformamide, N-methyl-2-pyrrolidone, dimethylsulfoxide and dimethylurea. These solvents may be used in combination with alcohol solvents such as methanol, ethanol, n-propyl alcohol, iso-propyl alcohol and 1-methoxy-2-propanol.

The proton conductive compositions and membranes from the compositions can be suitably used as electrolytes for primary and secondary batteries, proton conductive membranes for display elements, sensors, signaling media and solid condensers, and ion exchange membranes.

### EXAMPLES

The present invention will be hereinafter described in greater detail by Examples presented below, but it should be construed that the invention is in no way limited to those Examples. In Examples, the sulfonic acid equivalent and the molecular weight were determined as described below.

(Sulfonic Acid Equivalent)

The polymer having a sulfonic group was washed until the pH of the washings reached neutrality, and free residual acids were removed. The polymer was then sufficiently washed with water and dried. A predetermined amount of the polymer was weighed out and dissolved in a THF/water mixed solvent. The resultant solution was mixed with phenolphthalein as an indicator and then titrated with an NaOH standard solution to obtain a point of neutralization, from which the sulfonic acid equivalent was determined.

(Molecular Weight)

The polyarylene having no sulfonic group was analyzed by GPC using a tetrahydrofuran (THF) solvent to measure the weight-average molecular weight in terms of polystyrene. The polyarylene having a sulfonic group was analyzed by GPC using a solvent consisted of N-methyl-2-pyrrolidone (NMP) mixed with lithium bromide and phosphoric acid, to measure the weight-average molecular weight in terms of polystyrene.

### Synthesis Example 1

A 1-L three-necked flask equipped with a stirrer, a thermometer, a cooling tube, a Dean-stark tube and a three-way nitrogen inlet tube, was charged with 67.3 g (0.20 mol) of 2,2-bis(4-hydroxyphenyl)-1,1,1,3,3,3-hexafluoropropane (bisphenol AF), 60.3 g (0.24 mol) of 4,4′-dichlorobenzophenone (4,4′-DCBP), 71.9 g (0.52 mol) of potassium carbonate, 300 ml of N,N-dimethylacetamide (DMAc) and 150 ml of toluene. With the flask in an oil bath, the contents were reacted by being stirred in a nitrogen atmosphere at 130° C. Reaction was carried out while the water resulting from the reaction was formed into an azeotropic mixture with toluene and was removed outside the system through the Dean-Stark tube. Water almost ceased to occur in about 3 hours, and most of the toluene was removed while gradually raising the reaction temperature from 130° C. to 150° C. After reaction had been made at 150° C. for 10 hours, 10.0 g (0.040 mol) of 4,4′-DCBP was added to carry out reaction for another 5 hours. Subsequently, the reaction liquid was cooled naturally and was filtered to remove precipitated by-product inorganic compounds. The filtrate was poured into 4 L of methanol to precipitate the product. The precipitated product was filtered off, dried and dissolved in 300 mL of tetrahydrofuran. The resultant solution was poured into 4 L of methanol to perform reprecipitation. Thus, 95 g of a desired compound was obtained (85% yield).

GPC (THF solvent) provided that the compound had a weight-average molecular weight (Mw) of 11,200 in terms of polystyrene. The compound was found to be soluble in THF, NMP, DMAc and sulfolane, and to have Tg (glass transition temperature) of 110° C. and a thermal decomposition temperature of 498° C. The compound was an oligomer having the formula (I) (hereinafter, the BCPAF oligomer):

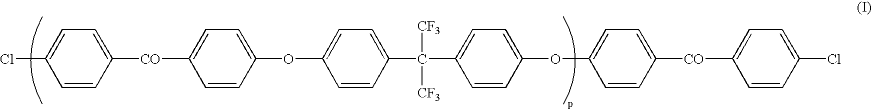

### Synthesis Example 2

A 1-L three-necked flask equipped with a stirrer, a thermometer, a cooling tube, a Dean-stark tube and a three-way nitrogen inlet tube, was charged, in a nitrogen atmosphere, with 39.58 g (98.64 mmol) of neo-pentyl 4-[4-(2,5-dichlorobenzoyl)phenoxy]benzenesulfonate (A-SO₃ neo-Pe), 15.23 g (1.36 mmol) of the BCPAF oligomer obtained in Synthesis Example 1, 1.67 g (2.55 mmol) of Ni(PPh₃)₂Cl₂, 10.49 g (40 mmol) of PPh₃, 0.45 g (3 mmol) of NaI, 15.69 g (240 mmol) of zinc powder and 390 ml of dry NMP. Reaction was carried out by heating the system (finally to 75° C.) with stirring for 3 hours. The polymerization solution was diluted with 250 ml of THF, stirred for 30 minutes, and filtered with use of Celite as filter aid. The filtrate was poured into large excess (1500 ml) of methanol to precipitate the product. The precipitated product was filtered off, air dried, then redissolved in THF/NMP (200/300 ml) and precipitated in large excess (1500 ml) of methanol. The precipitated product was air dried and then heat dried to give 47.0 g (99% yield) of anobjective yellow fibrous copolymer including a neopentyl-protected sulfonic acid derivative (Poly AB-SO₃neo-Pe). GPC provided a number-average molecular weight (Mn) of 47,600 and Mw of 159,000.

A 5.1 g portion of Poly AB-SO₃neo-Pe was dissolved in 60 ml of NMP, and the resultant solution was heated to 90° C. To the reaction system, a mixture consisting of 50 ml of methanol and 8 ml of concentrated hydrochloric acid was added all at once. Reaction was carried out under mild reflux conditions for 10 hours while maintaining the dispersion state. Excess methanol was distilled away using a distillation apparatus equipped, and a light green transparent solution resulted. The solution was then poured into an excess of water/methanol (1:1 by weight) to precipitate the polymer. Subsequently, the polymer was washed with ion exchange water until pH of the washings became 6 or greater. Polymer's IR spectrum and quantitative analysis for ion exchange capability provided that the sulfonate groups (—SO₃R^{a}) had been quantitatively converted to the sulfonic groups (—SO₃H).

GPC for the polyarylene copolymer having a sulfonic group gave Mn of 53,200 and Mw of 185,000. The sulfonic acid equivalent was 1.9 meq/g.

### Example A1

60 g of the polyarylene with a sulfonic group obtained in Synthetic Example 2 was placed in a 1000 cc plastic bottle, and was dissolved by addition of 340 g of y-butyrolactone. The solution was then combined with 6 g of tungsten oxide hydrate (10 wt % relative to the polyarylene), and the mixture was mixed with a disperser for 20 minutes to give a uniform dispersion.

The dispersion was cast over a PET film by a bar coater method, and the resultant coating was dried at 80° C. for 30 minutes and then at 140° C. for 60 minutes to give a solid electrolyte film (1) having a uniform thickness of 40 μm.

### Example A2

60 g of the polyarylene with a sulfonic group obtained in Synthetic Example 2 was placed in a 1000 cc plastic bottle, and was dissolved by addition of 340 g of y-butyrolactone. The solution was then combined with 12 g of molybdenum oxide hydrate (20 wt % relative to the polyarylene), and the mixture was mixed with a disperser for 20 minutes to give a uniform dispersion.

The dispersion was cast over a PET film by a bar coater method, and the resultant coating was dried at 80° C. for 30 minutes and then at 140° C. for 60 minutes to give a solid electrolyte film (2) having a uniform thickness of 42 μm.

### Comparative Example A1

60 g of the polyarylene with a sulfonic group obtained in Synthetic Example 2 was placed in a 1000 cc plastic bottle, and was dissolved by addition of 340 g of γ-butyrolactone.

The solution was cast over a PET film by a bar coater method, and the resultant coating was dried at 80° C. for 30 minutes and then at 140° C. for 60 minutes to give a solid electrolyte film (3) having a uniform thickness of 41 μm.

### Comparative Example A2

291.3 g of a solution of 20.6 wt % Nafion (trade name, available from DuPont) in a water-alcohol solvent (water:alcohol (weight ratio)=20:60) was placed in a 1000 cc plastic bottle, and was dissolved by addition of 108.7 g of n-propyl alcohol. The solution was then combined with 12 g of molybdenum oxide hydrate (20 wt % relative to the polymer), and the mixture was mixed with a disperser for 20 minutes to give a uniform dispersion. The alcohol in the water-alcohol solution of Nafion consisted of ethanol and n-propyl alcohol.

The dispersion was cast over a PET film by a bar coater method, and the resultant coating was dried at 80° C. for 60 minutes to give a solid electrolyte film (4) having a uniform thickness of 43 μm.

### Evaluation

The solid electrolyte films obtained in Examples A1 and A2 and Comparative Examples A1 and A2 were tested by the method and under the conditions described below to measure the proton conductance. The results are shown in Table 1.

(Proton Conductance)

A 5 mm wide strip specimen of the proton conductive membrane, holding five platinum wires (0.5 mm diameter) at intervals of 5 mm on its surface, was placed in a thermo-hygrostat. Subsequently, the alternating current impedance between the platinum wires was measured at 100° C., 120° C. and 150° C., and a saturated vapor pressure and 10 kHz. This measurement was carried out using a chemical impedance measuring system (NF Corporation) and thermo-hygrostat JW241 (Yamato Science Co., Ltd.). The alternating current resistance was measured in each case where the interwire distance was changed from 5 mm to 20 mm among the five platinum wires. The resistivity of the membrane was calculated by the following equation from a gradient between the interwire distance and the resistance. The reciprocal number of resistivity was obtained as the alternating current impedance, from which the proton conductance was calculated.
Resistivity R (Ω·cm)=0.5 (cm)×membrane thickness (cm)×resistance/interwire distance gradient (Ω/cm)

TABLE 1

| | | | Metal | | | |
|---|---|---|---|---|---|---|
| | | | oxide | | | |
| | | | hydrate | | | |
| | | | relative | | | |
| | | Metal | to | Proton conductance | | |
| | Polymer | oxide | polymer | (S/cm) | | |
| | matrix | hydrate | (wt %) | 100° C. | 120° C. | 150° C. |
| Ex. | Synthetic | Tungsten | 10 | 0.35 | 0.39 | 0.41 |
| A1 | Example 2 | oxide | | | | |
| | polymer | hydrate | | | | |
| Ex. | Synthetic | Molybdenum | 20 | 0.34 | 0.37 | 0.40 |
| A2 | Example 2 | oxide | | | | |
| | polymer | hydrate | | | | |
| Comp. | Synthetic | None | 0 | 0.30 | 0.10 | 0.01 |
| Ex. | Example 2 | | | | | |
| A1 | polymer | | | | | |
| Comp. | Nafion | Molybdenum | 20 | 0.16 | 0.16 | 0.16 |
| Ex. | | oxide | | | | |
| A2 | | hydrate | | | | |

### Example B1

60 g of the polyarylene with a sulfonic group obtained in Synthetic Example 2 was placed in a 1000 cc plastic bottle, 15 and was dissolved by addition of 340 g of γ-butyrolactone. The solution was then combined with 3 g (5 wt % relative to the polyarylene) of synthetic zeolite (trade name: Molecular sieve 23364-1, available from Aldrich), and the mixture was mixed with a disperser for 20 minutes to give a uniform dispersion.

The dispersion was cast over a PET film by a bar coater method, and the resultant coating was dried at 80° C. for 30 minutes and then at 140° C. for 60 minutes to give a solid electrolyte film (5) having a uniform thickness of 41 μm.

### Example B2

60 g of the polyarylene with a sulfonic group obtained in Synthetic Example 2 was placed in a 1000 cc plastic bottle, and was dissolved by addition of 340 g of γ-butyrolactone. The solution was then combined with 6 g (10 wt % relative to the polyarylene) of silica (trade name: Aero Gel 380, available from Japan AeroGel, Co., Ltd.), and the mixture was mixed with a disperser for 20 minutes to give a uniform dispersion.

The dispersion was cast over a PET film by a bar coater method, and the resultant coating was dried at 80° C. for 30 minutes and then at 140° C. for 60 minutes to give a solid electrolyte film (6) having a uniform thickness of 40 μm.

### Comparative Example B1

60 g of the polyarylene with a sulfonic group obtained in Synthetic Example 2 was placed in a 1000 cc plastic bottle, and was dissolved by addition of 340 g of γ-butyrolactone.

The solution was cast over a PET film by a bar coater method, and the resultant coating was dried at 80° C. for 30 minutes and then at 140° C. for 60 minutes to give a solid electrolyte film (7) having a uniform thickness of 43 μm.

### Comparative Example B2

291.3 g of a solution of 20.6 wt % Nafion (trade name, available from DuPont) in a water-alcohol solvent (water:alcohol (weight ratio)=20:60) was placed in a 1000 cc plastic bottle, and was dissolved by addition of 108.7 g of n-propyl alcohol. The solution was then combined with 6 g (10 wt % relative to the polymer) of silica (trade name: Aero Gel 380, available from Japan AeroGel, Co., Ltd.), and the mixture was mixed with a disperser for 20 minutes to give a uniform dispersion. The alcohol in the water-alcohol solution of Nafion consisted of ethanol and n-propyl alcohol.

The dispersion was cast over a PET film by a bar coater method, and the resultant coating was dried at 80° C. for 60 minutes to give a solid electrolyte film (8) having a uniform thickness of 44 μm.

### Evaluation

The solid electrolyte films obtained in Examples B1 and B2 and Comparative Examples B1 and B2 were tested by the method and under the conditions described below to measure the proton conductance. The results are shown in Table 2.

(Proton Conductance)

A 5 mm wide strip specimen of the proton conductive membrane, holding five platinum wires (0.5 mm diameter) at intervals of 5 mm on its surface, was placed in a thermo-hygrostat. Subsequently, the alternating current impedance between the platinum wires was measured at 85° C., 10 kHz and RH of 40%, 50%, 70% and 90%. This measurement was carried out using a chemical impedance measuring system (NF Corporation) and thermo-hygrostat JW241 (Yamato Science Co., Ltd.). The alternating current resistance was measured in each case where the interwire distance was changed from 5 mm to 20 mm among the five platinum wires. The resistivity of the membrane was calculated by the following equation from a gradient between the interwire distance and the resistance. The reciprocal number of resistivity was obtained as the alternating current impedance, from which the proton conductivity was calculated.
Resistivity R (Ω·cm)=0.5 (cm)×membrane thickness (cm)×resistance/interwire distance gradient (Ω/cm)

TABLE 2

| | | | Hygro- | | | | |
|---|---|---|---|---|---|---|---|
| | | | scopic | | | | |
| | | | porous | | | | |
| | | | com- | | | | |
| | | | pound | | | | |
| | | | relative | Proton conductance | | | |
| | | Hygroscopic | to | at 85° C. (S/cm) | | | |
| | Polymer | porous | polymer | 90% | 70% | 50% | 40% |
| | matrix | compound | (wt %) | RH | RH | RH | RH |
| Ex. | Synthetic | Synthetic | 5 | 0.335 | 0.134 | 0.045 | 0.035 |
| B1 | Example 2 | Zeolite | | | | | |
| | polymer | | | | | | |
| Ex. | Synthetic | Silica | 10 | 0.340 | 0.135 | 0.046 | 0.037 |
| B2 | Example 2 | | | | | | |
| | polymer | | | | | | |
| Comp. | Synthetic | None | 0 | 0.326 | 0.112 | 0.032 | 0.022 |
| Ex. | Example 2 | | | | | | |
| B1 | polymer | | | | | | |
| Comp. | Nafion | Silica | 10 | 0.159 | 0.081 | 0.040 | 0.033 |
| Ex. | | | | | | | |
| B2 | | | | | | | |

1. A proton conductive composition comprising:
(a) at least one compound selected from a metal oxide hydrate, a phyllosilicate and a hygroscopic inorganic porous compound, and
(b) a polyarylene having a sulfonic group.

2. A proton conductive composition comprising:
(a-1) at least one compound selected from a metal oxide hydrate and a phyllosilicate, and
(b) a polyarylene having a sulfonic group.

3. The proton conductive composition according to claim 1 or 2, wherein the metal oxide hydrate is at least one compound selected from the group consisting of tungsten oxide hydrate, tungsten oxide hydrate doped with niobium, tin oxide hydrate, silicon oxide hydrate, phosphorous oxide hydrate, silicon oxide hydrate doped with zirconia oxide hydrate, uranyl phosphate hydrate and molybdenum oxide hydrate.

4. The proton conductive composition according to claim 1 or 2, wherein the phyllosilicate is at least one compound selected from the group consisting of montmorillonite, saponite, hectorite, stevensite, vermiculite, fluorotetrasilicic mica and taeniolite.

5. The proton conductive composition according to claim 2, wherein the component (a-1) is contained in an amount of 0.5 to 80 parts by weight based on 100 parts by weight of the component (b).

6. A proton conductive composition comprising:
(a-2) a hygroscopic inorganic porous compound and
(b) a polyarylene having a sulfonic group.

7. The proton conductive composition according to claim 1 or 6, wherein the hygroscopic inorganic porous compound is at least one compound selected from the group consisting of silica, synthetic zeolite, particles in a titania, alumina, zirconia or yttria gel, and silica fibers.

8. The proton conductive composition according to claim 6, wherein the component (a-2) is contained in an amount of 0.01 to 60 parts by weight based on 100 parts by weight of the component (b).

9. The proton conductive composition according to any one of claims 1 to 8, wherein the polyarylene having a sulfonic group includes a structural unit represented by the following formula (A) and a structural unit represented by the following formula (B): 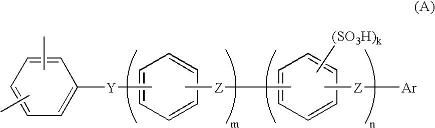
wherein Y is a divalent electron-withdrawing group; Z is a divalent electron-donating group or a direct bond; Ar is an aromatic group with a substituent —SO₃H; m is an integer of 0 to 10; n is an integer of 0 to 10; and k is an integer of 1 to 4; 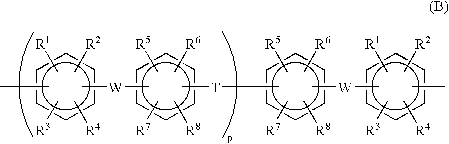
wherein R¹ to R⁸ may be the same or different and are each one or more atoms or groups selected from the group consisting of a hydrogen atom, a fluorine atom, an alkyl group, a fluorine-substituted alkyl group, an allyl group, an aryl group and a cyano group; W is a divalent electron-withdrawing group or a single bond; T is a divalent organic group or a single bond; and p is 0 or a positive integer.

10. A proton conductive membrane comprising the proton conductive composition as described in any one of claims 1 to 9.
